(19) United States
(12) Patent Application Publication
(10) Pub. No.: US 2018/0372766 A1
(43) Pub. Date: Dec. 27, 2018

(54) Analysis Systems and Methods of Identifying Consumables and Reagents

(71) Applicant: Abbott Molecular Inc., Des Plaines, IL (US)

(72) Inventors: Jason E. Bryant, Eliot, ME (US); Brett W. Johnson, Naperville, IL (US); Arthur Martinez, Des Plaines, IL (US); Frank Pawlowski, Amherst, NH (US); Michael Silvestri, Des Plaines, IL (US)

(21) Appl. No.: 16/011,177

(22) Filed: Jun. 18, 2018

Related U.S. Application Data
(60) Provisional application No. 62/523,047, filed on Jun. 21, 2017.

(51) Int. Cl. G01N 35/00; G01N 35/10; B01L 3/00

(52) U.S. Cl. CPC G01N 35/00732; G01N 35/1002; B01L 2300/021; G01N 2035/00752; B01L 2200/16; B01L 3/52

(57) ABSTRACT

Provided are analysis systems that include components for identifying, inventorying, or both, consumables and/or reagents introduced into one or more consumable or reagent storage areas of the systems. The systems include a camera and camera positioning means for positioning the camera in optical communication with the one or more consumable or reagent storage areas. The systems further include one or more non-transitory computer-readable media including instructions that cause the system to detect when a consumable or reagent has been introduced to the one or more consumable or reagent storage areas, position the camera in optical communication with the introduced consumable or reagent, and identify the introduced consumable or reagent. Also provided are automated methods for identifying, inventorying, or both, consumables and/or reagents introduced into one or more consumable or reagent storage areas of an analysis system.

### CROSS-REFERENCE TO RELATED APPLICATIONS

Pursuant to 35 U.S.C. § 119(e), this application claims priority to the filing date of the U.S. Provisional Patent Application Ser. No. 62/523,047, filed Jun. 21, 2017, the disclosure of which application is herein incorporated by reference.

### BACKGROUND

Molecular diagnostic assays, including nucleic acid amplification based methods, have become a mainstay of clinical medicine and the variety of available tests and the demand for such tests by clinicians has increased dramatically. This demand places increasing pressures on clinical laboratories to process, not only a greater volume of samples, but also a greater diversity of tests on the samples.

To perform molecular diagnostic assays in an automated sample processing instrument, patient samples as well as control samples must be loaded into the instrument and tracked throughout the processing. The variability in the assays that may be requested, variability in the type of sample tubes that may arrive in a diagnostic laboratory and variability in the length of processing time for each assay complicates sample loading and tracking. For example, a number of different assays, i.e., assays to detect different analytes, may arrive at a diagnostic testing facility at any one time. In addition, the containers in which the samples arrive may be of different sizes and shapes. Furthermore, a laboratory may have already begun processing samples through an assay of extended length when samples arrive in the facility that should only require a minimal time for processing. All of these scenarios, in isolation or combination, add increasing complexity to processes of sample loading in multiplexed molecular diagnostic devices.

In performing assays in an automated molecular diagnostics instrument, it is important for the instrument to know what consumables and reagents are loaded and where they are located within the system. This can be carried out by having the operator manually enter this information, but it would be preferred for the instrument to have the capability to perform its own inventory of consumables and reagents, thereby reducing operator time on the instrument and eliminating errors caused by incorrect operator input.

### SUMMARY

Provided are analysis systems that include components for identifying, inventorying, or both, consumables and/or reagents introduced into one or more consumable or reagent storage areas of the systems. The systems include a camera and camera positioning means for positioning the camera in optical communication with the one or more consumable or reagent storage areas. The systems further include one or more non-transitory computer-readable media including instructions that cause the system to detect when a consumable or reagent has been introduced to the one or more consumable or reagent storage areas, position the camera in optical communication with the introduced consumable or reagent, and identify the introduced consumable or reagent. Also provided are automated methods for identifying, inventorying, or both, consumables and/or reagents introduced into one or more consumable or reagent storage areas of an analysis system.

### BRIEF DESCRIPTION OF THE FIGURES

FIG. 1 is an illustration of an analysis system having consumable and reagent storage areas, and a camera for identifying consumables and/or reagents introduced into the analysis system, according to one embodiment of the present disclosure.

FIG. 2 is an illustration of a pipettor head and pipettor head positioning means according to one embodiment of the present disclosure.

FIG. 3 depicts first (top) and second (bottom) pipette tip racks present at a consumable storage area of an analysis system, the racks holding small and large pipette tips, respectively, as identified by a camera of the system, according to one embodiment of the present disclosure.

FIG. 4 depicts assay reagent plates at a reagent storage area of an analysis system, each assay reagent plate having an identification code associated therewith, the identification codes being readable by a camera of the system for identifying the type of assay reagent present in each plate, according to one embodiment of the present disclosure.

FIG. 5 depicts caps of auxiliary reagent containers present at a reagent storage area of an analysis system, each of the auxiliary reagent container caps having an identification code present thereon, the identification codes being readable by a camera of the system for identifying the type of auxiliary reagents present at a reagent storage area, according to one embodiment of the present disclosure.

### DETAILED DESCRIPTION

Provided are analysis systems that include components for identifying, inventorying, or both, consumables and/or reagents introduced into one or more consumable or reagent storage areas of the systems. The systems include a camera and camera positioning means for positioning the camera in optical communication with the one or more consumable or reagent storage areas. The systems further include one or more non-transitory computer-readable media including instructions that cause the system to detect when a consumable or reagent has been introduced to the one or more consumable or reagent storage areas, position the camera in optical communication with the introduced consumable or reagent, and identify the introduced consumable or reagent. Also provided are automated methods for identifying, inventorying, or both, consumables and/or reagents introduced into one or more consumable or reagent storage areas of an analysis system.

Before the analysis systems and methods of the present disclosure are described in greater detail, it is to be understood that the analysis systems and methods are not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the analysis systems and methods. The upper and lower limits of these smaller ranges may independently be included in the smaller ranges and are also encompassed within the analysis systems and methods, subject to any specifically excluded limit in the stated range. Where the stated range includes one or both of the limits, ranges excluding either or both of those included limits are also included in the analysis systems and methods.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which the analysis systems and methods belong. Although any methods and materials similar or equivalent to those described herein can also be used in the practice or testing of the analysis systems and methods, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reviewing the present disclosure, each of the individual embodiments described and illustrated herein has discrete components and features which may be readily separated from or combined with the features of any of the other several embodiments without departing from the scope or spirit of the analysis systems and methods. Any recited method can be carried out in the order of events recited or in any other order which is logically possible.

### Analysis Systems

As summarized above, the present disclosure provides analysis systems. In certain aspects, an analysis system of the present disclosure includes one or more consumable or reagent storage areas (e.g., one or more consumable storage areas and one or more reagent storage areas), a camera, and camera positioning means for positioning the camera in optical communication with the one or more consumable or reagent storage areas. Such systems also include one or more non-transitory computer-readable media including instructions that cause the system to: detect when a consumable or reagent has been introduced to the one or more consumable or reagent storage areas; using the camera positioning means, position the camera in optical communication with the introduced consumable or reagent; and using the camera, identify the introduced consumable or reagent.

Analysis systems of the present disclosure may be adapted to perform one or more of a variety of analyses of interest, including but not limited to, nucleic acid analysis, hematology analysis, and/or the like. In certain aspects, the analysis systems are automated, meaning that the system is capable of performing sample analysis and any necessary sample preparation steps without user intervention. The methods of the present disclosure may include any of the functions performed by the analysis systems of the present disclosure, in any suitable combination.

The term “analysis” includes any form of measurement, and includes determining, e.g., if an analyte is present or not. The terms “analyzing”, “determining”, “measuring”, “evaluating”, “assessing” and “assaying” are used interchangeably and include quantitative and qualitative determinations. The analysis may be relative or absolute.

The term “sample” includes research, clinical (e.g., biopsy, etc.), and environmental samples. In certain aspects, the sample is a tissue or body fluid, or a derivative of a tissue or body fluid. Samples include those that have been manipulated in any way after their procurement, such as by mixing or pooling of individual samples, treatment with reagents, solubilization, or enrichment for certain components, such as nucleated cells, non-nucleated cells, pathogens, etc. Body fluids of interest include, but are not limited to, blood, a blood fraction, plasma, serum, urine, saliva, sputum, mucus, cerebrospinal fluid, peritoneal fluid, interstitial fluid, ocular fluid, synovial fluid, and the like.

According to certain embodiments, the analysis system is an automated nucleic acid preparation and analysis system. In certain aspects, the automated nucleic acid preparation and analysis system of the present disclosure is designed to perform automated nucleic acid preparation and analysis (e.g., while an operator of the system has access to replenish consumables and reagents, remove waste, and/or the like) and finds use, e.g., for performing nucleic acid testing in a clinical laboratory. The system may be a fully integrated and automated molecular diagnostics analyzer that utilizes real-time PCR technology in clinical laboratories. The system may be integrated such that it performs both sample preparation (e.g., nucleic acid isolation and purification) and analysis (e.g., real-time PCR analysis). The systems may isolate, wash, purify and amplify a DNA or RNA target of interest from a sample of interest (e.g., plasma, serum, whole blood, body fluid, swab sample, etc.) from one or a variety of sample container types, e.g., sample tubes that may vary in one or more of size, shape, the presence or type of sample tube cap, and the like.

In certain aspects, the systems of the present disclosure include redundant components for sample processing and nucleic acid analysis, redundant loading/storage areas for, e.g., samples, reagents, and consumables (e.g., sample processing cartridges, pipette tips) and/or the like. Such redundant components enable the system to run (including presenting sample results/data) continuously and provide continuous operator access during the replenishment or removal of samples, bulk fluids, reagents, commodities (e.g., reaction vessels and reaction vessel caps, sample processing (SP) cartridges, pipette tips and trays, assay plates, auxiliary reagent packs, and/or the like), and waste, without ceasing operation of the system. By “continuous operator access” is meant an operator of the system can replenish and/or remove samples, bulk fluids, reagents, commodities, and waste without ceasing operation of the system, e.g., without interrupting any aspect of the sample preparation and analysis functions of the system.

According to certain embodiments, systems of the present disclosure provide random access to all assays, meaning that the system permits the ordering of any test (assay) in any order provided that the system has the necessary reagents/consumables for requested test. The total number of assays may vary, and in certain aspects is 2 or more, 5 or more, 10 or more, 15 or more, 20 or more, 30 or more, 40 or more (e.g., 48 or more), or 50 or more assays in parallel. The assays may be the same or different. Any assays of interest may be performed. In certain aspects, the system performs assays to detect the presence or absence of microbial nucleic acids in a sample. For example, the system may include assay reagents for carrying out real-time PCR analysis to determine the presence or absence in the sample of a bacterial nucleic acid, viral nucleic acid, yeast nucleic acid, and/or the like. In certain aspects, the system includes reagents for testing for the presence or absence of a nucleic acid from one or more of human immunodeficiency virus (HIV), Hepatitis C virus (HCV), Hepatitis B virus (HBV), Chlamydia trachomatis (CT), Neisseria gonorrhoeae (NG), Human papillomavirus (HPV), Cytomegalovirus (CMV), Epstein-Barr virus (EBV), Polyomavirus BK (BKV), Methicillin-resistant Staphylococcus aureus (MRSA), Clostridium difficile (C. Diff.), Vancomycin-resistant enterococci (VRE), adenovirus, Mycobacterium tuberculosis (TB), Varicella Zoster Virus (VZV), Herpes simplex virus (HSV), John Cunningham virus (JCV), enterovirus, Lymphogranuloma Venereum (LGV), viruses of a Respiratory Viral Panel (RVP), Human Herpesvirus 6 (HHV6), Trichomonas vaginalis, Mycoplasma genitalium, norovirus, and zika virus.

In some embodiments, an analysis system of the present disclosure includes a sample loading area. The sample loading area may include one or more (e.g., two or more) sample loading positions. According to certain embodiments, samples loaded into the system are present in sample tubes. Sample tubes may be loaded into the system individually, or may be loaded together with other sample tubes within a sample tube rack. When sample tube racks are employed, a sample loading position may be a lane into which a rack is loaded. The sample loading area may include one or any desired number of lanes. In certain aspects, the loading area includes from 2 to 20 lanes, such as from 5 to 15 lanes (e.g., 12 lanes).

As summarized above, an analysis system of the present disclosure includes one or more consumable or reagent storage areas. By “one or more consumable or reagent storage areas” is meant the system may include: a single consumable storage area and no reagent storage area; two or more (e.g., 2, 3, 4, 5, etc.) consumable storage areas and no reagent storage area; no consumable storage area and a single reagent storage area; no consumable storage area and two or more (e.g., 2, 3, 4, 5, etc.) reagent storage areas; or two or more (e.g., 2, 3, 4, 5, etc.) consumable storage areas and two or more (e.g., 2, 3, 4, 5, etc.) reagent storage areas. When two or more consumable storage areas and/or two or more reagent storage areas are present, the storage areas may be for holding the same or different consumables/reagents.

Consumables of interest include, but are not limited to, pipette tips, sample preparation (SP) cartridges, tubes, plates, reaction vessels (e.g., reaction vessels adapted for thermocyling, e.g., quantitative polymerase chain reaction (qPCR)), and the like. Reagents of interest include, but are not limited to, auxiliary reagents (e.g., magnetic particles for capturing nucleic acids at the sample preparation station, elution buffer for eluting purified nucleic acids at the sample preparation station, and/or the like), assay reagents (e.g., reagents which are combined with samples subsequent to sample preparation and are necessary for the system to perform a desired assay/analysis), bulk reagents (e.g., reagents that may be dispensed into a destination vessel (e.g., a sample preparation cartridge) with a pump and nozzle and do not require special manipulation, e.g., resuspension of the container's contents, examples of which include lysis buffer, alcohol (e.g., ethanol), nucleic acid wash solutions, molecular grade water, vapor barrier reagent(s), and/or the like), and the like.

An analysis system of the present disclosure may include one or more of any of the consumables described herein, one or more of any of the reagents described herein, or any combinations thereof. The number and/or configuration of the one or more consumable or reagent storage areas will vary depending upon which consumable(s) and/or reagent(s) are provided to the system.

As summarized above, an analysis system of the present disclosure includes a camera. In some embodiments, the camera is a digital camera. Suitable digital cameras will vary and will generally include any digital camera with sufficiently high resolution to capture an image that may be utilized to identify, etc. consumables and/or reagents at storage areas of the analysis system. In certain aspects, the digital camera is adapted to capture digital images of a consumable (or portion and/or plurality thereof), consumable container (or portion and/or plurality thereof), reagent container (or portion and/or plurality thereof), any identification code(s) present thereon, and/or the like.

By “digital image” is meant a numeric representation (e.g., binary representation) of a two- or three-dimensional image that may be of fixed or unfixed resolution. Fixed resolution images have a fixed number of rows and columns of pixels in an XY orientation. In some instances, digital images may be three-dimensional having fixed number of voxels in a XYZ orientation. Pixels and voxels are stored in computer memory as a raster image or raster map, a two-dimensional or three-dimensional array of small integers transmitted or stored in an uncompressed or compressed form. Suitable digital image file formats include but are not limited to, e.g., BMP, BPG, CD5, DEEP, ECW, Exif, FITS, FLIF, GIF, HDR, HEIF, ILBM, ILBM, IMG, IMG, JPEG 2000, JPEG XR, JPEG/JFIF, Layered Image File Format, Nrrd, PAM, PBM, PCX, PGF, PGM, PLBM, PNG, PNM, PPM, SGI, SID, Sun Raster, TGA, TIFF, VICAR, WEBP, and the like.

Digital images may be a variety of image bit depths depending, e.g., on the particular type of image captured (e.g., color or grayscale) and the sensitivity or the digital camera or other image capture device and may include but are not limited to e.g., 8-bit, 10-bit, 12-bit, 14-bit, 16-bit, 18-bit, 24-bit, 30-bit, 36-bit, 48-bit, 64-bit, and the like. In some instances, the channels of a color image may individually be or may be split into individual 8-bit grayscale images. In some instances, the channels of a color image may individually be or may be split into individual 16-bit grayscale images.

Following capture of digital images by the digital camera, the images may be transferred to a computing device. Transferred images may be processed immediately following acquisition or may be stored for some length of time on a suitable device or medium prior to processing. Digital images may be transferred by a data or computer connection or may be received on a computer readable medium.

The systems and/or methods of the present disclosure may include processing an image of a consumable (e.g., the consumable itself or a container containing same) reagent (e.g., the reagent itself or a container containing same), and/or an identification code present thereon, to identify and/or detect certain attributes of the consumable and/or reagent. Non-limiting examples of consumable attributes include the type of consumable (e.g. pipette tip, sample preparation cartridge, reaction vessel, etc.), a dimension of the consumable (e.g., to identify the size of a particular consumable, e.g., large pipette tip versus small pipette tip), the number of consumables present (e.g., the number of pipette tips present in a pipette tip rack, etc.), and/or the like. Non-limiting examples of reagent attributes include the type of reagent (e.g., the type(s) of reagent(s) present in an assay plate, the type of auxiliary reagent present in an auxiliary reagent container), the amount of one or more reagents present in one or more reagent containers, the number of reagents present, and/or the like.

Image processing functions may vary. In some instances, a captured image may be segmented through one or more image segmentation processes. As used herein, the terms “segmented” and “segmentation” as they relate to image processing generally refer to the division or partitioning of an image into meaningful structures or segments. Various approaches for image segmentation may find use in the systems and methods described herein or in preparation of an image for processing according to the systems and methods described herein. Selection of a particular segmentation approaches or combination of segmentation approaches will depend on various factors including the type of image captured, the nature of subject matter of the image, the desired result of the image processing, attributes to be extracted, etc.

Image segmentation may be utilized to generate one or more regions of interest (ROI) and, in some instances, an image mask may be generated based on the segmented ROI such that further image processing steps are limited only to those pixels contained within the mask defined by the segmented ROI. Various masks may be generated depending on the particular processes to be performed. For example, a ROI may be generated for a consumable, rack, reagent container, or a portion thereof of interest (e.g., an identification code). Where a plurality of consumables, racks, reagent containers, portions thereof of interest, and/or the like are present, an ROI may be generated for each of the plurality and each ROI may be processed separately, e.g., to identify or obtain attributes for each. Where multiple ROIs are employed, the multiple ROIs may be obtained from a single image or from across multiple images or multiple ROIs may be obtained from each of a plurality of images. Image processing may include extracting a value from the image or a value over an obtained ROI. Non-limiting examples of values that may be extracted include color values, intensity (e.g., brightness, shading, etc.) values, shape values (e.g., circularity, aspect ratio, slope, angle, etc.), size values (e.g., length, width, diameter, etc.), and combinations thereof.

In some instances, a computer memory of the system may include a library of reference values to which measured values may be compared. Comparison of measured values to one or more known reference values (e.g., of a reference value library) may, in some instances, facilitate the identification of consumables, reagents, and/or attributes thereof.

Processing of images using a computing device may produce various results including but not limited to, e.g., automatically identifying one or more introduced consumables, introduced reagents, and/or attributes thereof (e.g., size, amount, etc.).

In some embodiments, an identification code is present on one or more consumables or containers therefor, one or more reagents or containers therefor, or both. In certain aspects, the identification code is a barcode (e.g., a one-dimensional (1D) barcode, a two-dimensional (2D) code (e.g., a multiple-barcode layout, a 2D stacked barcode, a 2D matrix code, and the like), a numeric code, individually-generated unique images, custom graphics, and any combinations thereof. According to one embodiment, the unique identifier is a 2D matrix code. 2D matrix codes of interest include, but are not limited to, Quick Response (QR) codes, DataMatrix codes, Aztec codes, MaxiCode, Semacode tags, Cauzin Softstrip codes, EZcode, High Capacity Color Barcode (HCCB), CyberCode, Mobile Multi-Coloured Composite (MMCC), Dot codes, PDF417 symbols, ShotCode, SPARQCode, WaterCode, and Trusted Paper Key (TPK).

In certain aspects, the identification code is printed upon, adhered to, or etched into the consumable, consumable container, reagent container, plate, rack, and/or the like.

In some instances, the systems and methods of the present disclosure include assessing whether data obtained from one or more identification codes (e.g., barcodes) is consistent with (i.e., matches) information extracted from an image of the consumable, reagent, and/or container therefor.

As summarized above, an analysis system of the present disclosure includes a camera positioning means for positioning the camera in optical communication with the one or more consumable or reagent storage areas. Any suitable camera positioning means may be employed. The camera positioning means may vary depending on the type and configuration of the analysis system, the number of consumable or reagent storage areas, the spatial relationship and/or distances between same, etc. In certain aspects, the camera positioning means includes means for moving the camera in 2 or more dimensions. For example, the camera positioning means may include means for moving the camera in X, Y and Z axes. In certain aspects, the camera positioning means includes a linear actuator, a rotary actuator, or both. The camera positioning means may include one or more motors. The one or more motors may be a drive motor. In some embodiments, the one or more motors includes a motor coupled to a position sensor. For example, the camera positioning means may include one or more servo motors. In some embodiments, the camera positioning means includes a robotic arm.

In certain aspects, an analysis system of the present disclosure includes a pipettor head, e.g., a pipettor head of a robotic pipettor. The robotic pipettor may include a pipettor head positioning means for positioning the pipettor head such that it can interact with one or more of the one or more consumable or reagent storage areas. For example, the robotic pipettor may include a pipettor head positioning means for positioning the pipettor head such that it can interact with, e.g., pipette tips at a pipette tip storage area; auxiliary reagents present at an auxiliary reagent storage area, assay reagents present at an assay reagent storage area, a pipette tip and/or reaction vessel waste location, and/or the like. In some embodiments, the pipettor is able to perform, e.g., transfer of samples and/or reagents to pretreatment or lysis wells of sample preparation (SP) cartridges, transfer pretreated samples from pretreatment wells to lysis wells; access eluate wells and/or auxiliary wells; fill reaction vessels (RVs) with eluate and reagents; access filled RVs on SP cartridges; access RV wells at an analysis station; and/or the like.

In some embodiments, when the analysis system includes a pipettor head and pipettor head positioning means, the pipettor head positioning means is the camera positioning means. According to some such embodiments, the camera is mounted on the pipettor head positioning means proximate to the pipettor head. By “proximate” is meant not mounted directly to the pipettor head, but some distance from the pipettor head (e.g., to a same or different component of the pipettor head positioning means to which the pipettor head is mounted). The distance between the pipettor head and camera may be, e.g., 50 cm or less, 40 cm or less, 30 cm or less, 25 cm or less, 20 cm or less, 15 cm or less, 10 cm or less, 9 cm or less, 8 cm or less, 7 cm or less, 6 cm or less, 5 cm or less, 4 cm or less, 3 cm or less, 2 cm or less, or 1 cm or less.

In some embodiments, when the pipettor head positioning means is the camera positioning means, the camera is mounted on the pipettor head (that is, mounted directly or indirectly (e.g., via attachment means) to a region of the pipettor head).

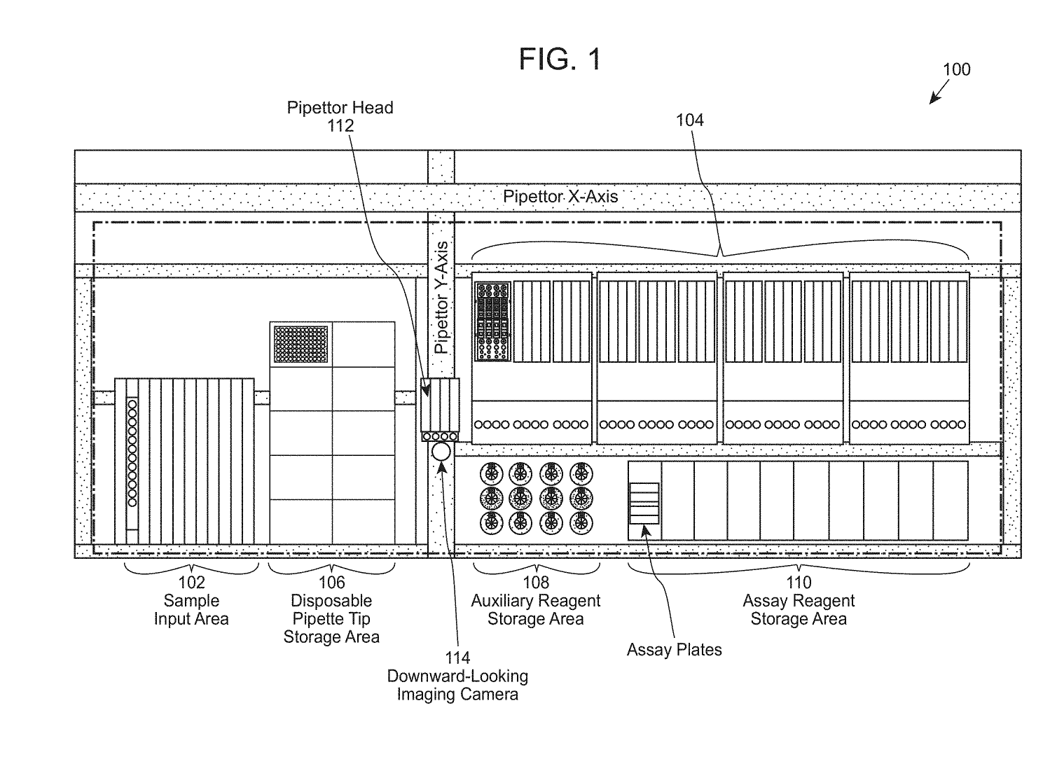

An analysis system according to one embodiment is shown in FIG. 1. As shown, analysis system 100 includes sample input area 102 and sample processing and analysis area 104. In this example, the analysis system includes at least one consumable storage area—pipette tip storage area 106. Also in this example, the analysis system includes at least two reagent storage areas—auxiliary reagent storage area 108 and assay reagent storage area 110.

Referring to FIG. 1, analysis system 100 includes pipettor head 112 having pipettor head positioning means for positioning pipettor head 112 such that it can interact with one or more (e.g., each) of sample input area 102, sample processing and analysis area 104, pipette tip storage area 106, auxiliary reagent storage area 108, and assay reagent storage area 110. Analysis system 100 further includes camera 114. In this example, the pipettor head positioning means is the camera positioning means. That is, the means for positioning pipettor head 112 for interacting with various stations/areas within the system is also the means for positioning the camera in optical communication with the one or more consumable or reagent storage areas, e.g., pipette tip storage area 106, auxiliary reagent storage area 108, assay reagent storage area 110, and/or the like.

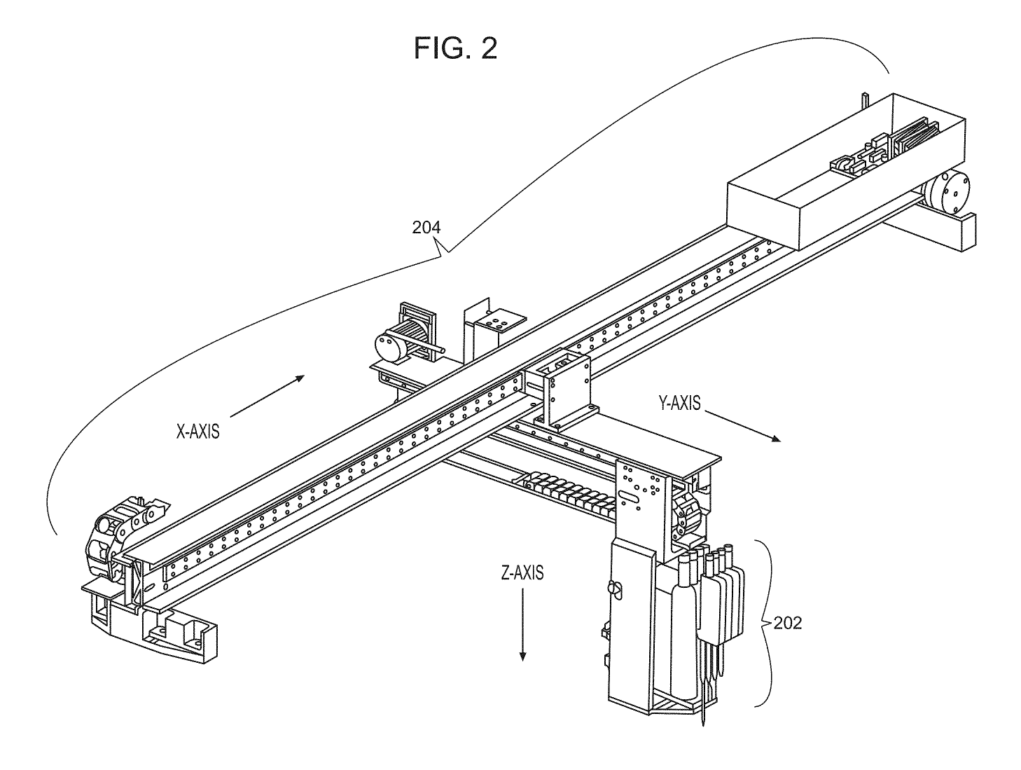

An example pipettor head and pipettor head positioning means is shown in FIG. 2. In this example, pipettor head 202 is mounted on a pipettor head positioning means 204 for moving the pipettor head in X, Y and Z axes (e.g., via drive/servo motor assemblies) for interaction with one or more (e.g., each) of the aforementioned system stations/areas. The camera (not shown) of the system may be mounted on the pipettor head positioning means proximate to the pipettor head, or may be mounted on the pipettor head (that is, mounted directly or indirectly (e.g., via attachment means) to a region of the pipettor head), such that the pipettor head positioning means is also the means for positioning the camera in optical communication with the one or more consumable or reagent storage areas.

In certain aspects, the one or more consumable or reagent storage areas includes one or more consumable storage areas. In some embodiments, the instructions cause the system to detect when a consumable (e.g., one or more pipette tip racks) has been introduced to the one or more consumable storage areas. In certain aspects, the instructions cause the system to, using the camera positioning means, position the camera in optical communication with the introduced consumable (e.g., one or more pipette tip racks). When one or more pipette tip racks are introduced at a consumable storage area of the system, the instructions may cause the system to, using the camera, identify the type of pipette tips present in the introduced one or more pipette tip racks. In certain aspects, the instructions cause the system to identify the type of pipette tips present in the introduced pipette tip rack based on an identification code present on the introduced pipette tip rack. In some embodiments, the instructions cause the system to identify the type of pipette tips present in the introduced pipette tip rack based on a dimension of the pipette tips. Any suitable identifying dimension may be utilized. In certain aspects, the dimension is that of the top opening of the pipette tips (that is, the opening opposite that through which fluids are aspirated/dispensed).

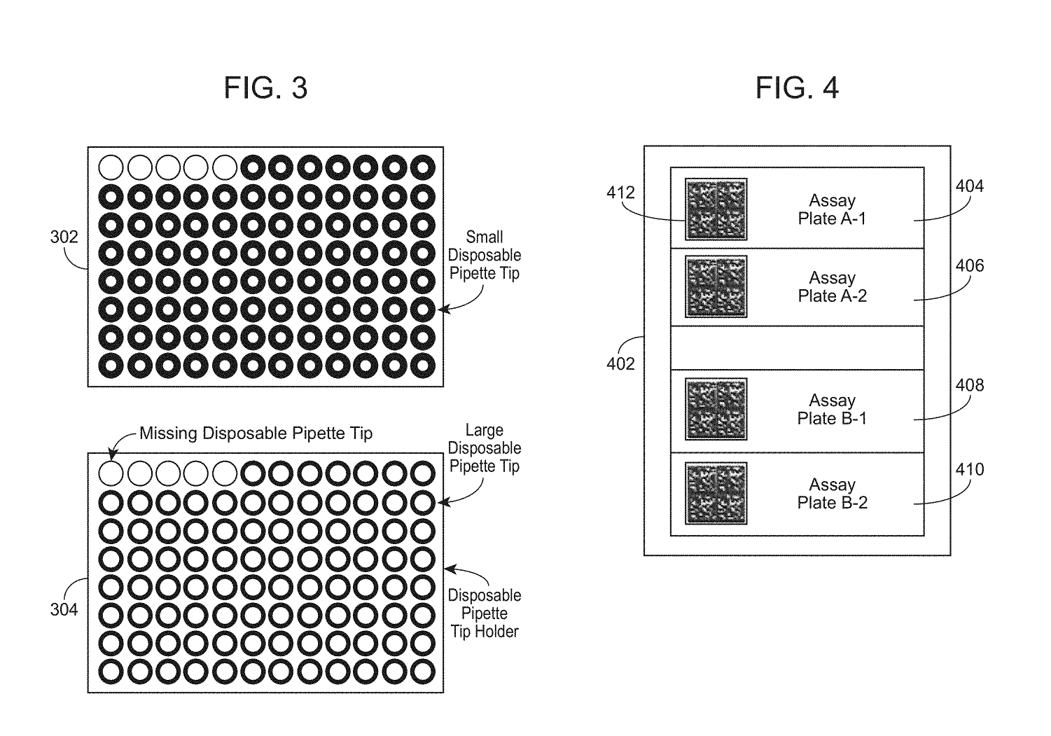

In certain aspects, as illustrated in the example embodiment shown in FIG. 3, the dimension may be that of a filter present in the top opening of filter tip pipette tips. Shown in this example is filter tip pipette tip rack 302 and filter tip pipette tip rack 304 present in a consumable storage area of the system (not shown). Pipette tip rack 302 holds small filter tip pipette tips while pipette tip rack 304 holds large filter tip pipette tips. The camera positioning means positions the camera in optical communication with the pipette tips, and the camera captures an image that includes the top opening of one or more of the filter tip pipette tips. Based on the dimension (e.g., diameter, circumference, and/or the like) of the filter present in the top opening, the system is able to determine whether an introduced rack includes small filter tip pipette tips or large filter tip pipette tips. Alternatively, or additionally, the camera captures an image of the pipette tip racks such that the system is able to determine whether one or more pipette tip positions of a pipette tip rack do not have pipette tips disposed therein, e.g., based on an optically detectable difference between a position that is empty and a positions having a pipette tip disposed therein. For example, in some embodiments, based on one or more images captured by the camera, the system is able to determine that a pipette tip rack present at a pipette tip storage area includes less than all of the pipette tips that the rack can accommodate, and optionally, which positions are vacant and which positions include pipette tips disposed therein. In some embodiments, the instructions cause the system to, using the camera, identify the number of pipette tips present in the introduced pipette tip rack.

In certain aspects, the one or more consumable or reagent storage areas includes one or more reagent storage areas. In some embodiments, the instructions cause the system to detect when a reagent (e.g., an assay reagent, auxiliary reagent, bulk reagent, and/or the like) has been introduced to the one or more reagent storage areas. In certain aspects, the instructions cause the system to, using the camera positioning means, position the camera in optical communication with the introduced reagent (e.g., a reagent or container including same, e.g., an assay reagent plate). When a reagent is introduced at a reagent storage area of the system, the instructions may cause the system to, using the camera, identify the type of reagent introduced to the reagent storage area, an attribute of the reagent (e.g., an expiration date of the reagent), and/or the like.

In some embodiments, the analysis system is adapted to perform nucleic acid amplification-based assays (e.g., real-time PCR and detection), and the assay reagents include one or more nucleic acid amplification reagents selected from amplification primers (e.g., labeled amplification primers) specific to a target of interest, a thermostable polymerase, a cofactor (e.g., Mg2+) for the polymerase, a buffer suitable for the assay, and/or the like. Amplification primers may be designed to amplify a target of interest in a clinical sample such as a genomic region, an RNA (or complementary DNA (cDNA) thereof), a nucleic acid specific to a microbe of interest (e.g., a bacteria, virus, etc. of interest), and any combinations thereof. In certain aspects, the assay reagents include primers for amplifying a nucleic acid from a microbe (e.g., to determine the presence or absence of that microbe in a clinical sample) selected from human immunodeficiency virus (HIV), Hepatitis C virus (HCV), Hepatitis B virus (HBV), Chlamydia trachomatis (CT), Neisseria gonorrhoeae (NG), Human papillomavirus (HPV), Cytomegalovirus (CMV), Epstein-Barr virus (EBV), Polyomavirus BK (BKV), Methicillin-resistant Staphylococcus aureus (MRSA), Clostridium difficile (C. Diff.), Vancomycin-resistant enterococci (VRE), adenovirus, Mycobacterium tuberculosis (TB), Varicella Zoster Virus (VZV), Herpes simplex virus (HSV), John Cunningham virus (JCV), enterovirus, Lymphogranuloma Venereum (LGV), viruses of a Respiratory Viral Panel (RVP), Human Herpesvirus 6 (HHV6), Trichomonas vaginalis, Mycoplasma genitalium, norovirus, zika virus, and any combination thereof.

Assay reagents may be introduced into the system in individual tubes. In other aspects, one or more plates that include the assay reagents are loaded into the system. The plates may be in any desired format (48-well, 96-well, 384-well, etc.). A plate may include the same assay reagents in each well of the plate, or the assay reagents in a plate may vary from well to well.

The reagents may be loaded into the system in liquid or non-liquid form. In certain aspects, the reagents loaded into the system are lyophilized. Lyophilized reagents have the advantage of being storage stable, such that lyophilized reagents loaded into the system are stable for extended periods of time, e.g., 30 days or more.

In the example of an assay reagent plate being introduced to a reagent storage area, the instructions may cause the system to, using the camera positioning means, position the camera in optical communication with the introduced assay reagent plate. In some embodiments, the instructions cause the system to identify the type of assay reagents present in the introduced assay reagent plate based on an image captured by the camera that includes an identification code present on the introduced assay reagent plate.

Assay reagent plates may be loaded into the system using one or more assay reagent plate carriers. An assay reagent plate carrier may include a single assay plate position, or two or more assay plate positions. When two or more assay reagent plates are present in an assay plate carrier, the reagents in each of the assay plates may be the same, or the reagents between different assay plates may be different. For example, each plate in a carrier may include the same assay reagents (that is, for running the same test, e.g., HIV), or a plate in a carrier may include different assay reagents from those in a different plate in the carrier. According to certain embodiments, the system includes assay plate carriers having assay plates such that 5 or more, 10 or more, 20 or more (e.g., 24 or more), 30 or more, 40 or more (e.g., 48 or more), or 50 or more different assays may be run in the system in parallel.

Shown in FIG. 4 is an example embodiment in which an assay reagent plate carrier including multiple assay reagent plates is introduced to a reagent storage area. In this example, assay reagent plate carrier 402 includes 4 assay reagent plates (plates 404, 406, 408 and 410). Also in this example, each assay reagent plate includes an identification code (in this example, a two-dimensional code, e.g., QR code 412 present on assay reagent plate 404). The instructions cause the camera positioning means to position the camera in optical communication with the identification codes (e.g., separately, or two or more at a time). The instructions cause the system to identify the type of assay reagents present in each of the assay reagent plates based on one or more images captured by the camera of the identification code(s) present on the assay reagent plates.

In certain aspects, when the one or more consumable or reagent storage areas includes one or more reagent storage areas, an auxiliary reagent is introduced to the one or more reagent storage areas. In some embodiments, the instructions cause the system to detect when an auxiliary reagent (e.g., an auxiliary reagent or container including same) has been introduced to an auxiliary reagent storage area. In certain aspects, the instructions cause the system to, using the camera positioning means, position the camera in optical communication with the introduced auxiliary reagent (e.g., an auxiliary reagent or container including same).

When an auxiliary reagent is introduced to an auxiliary reagent storage area of the system, the instructions may cause the system to, using the camera, identify the type of auxiliary reagent introduced to the reagent storage area, an attribute of the auxiliary reagent (e.g., an expiration date of the auxiliary reagent), and/or the like.

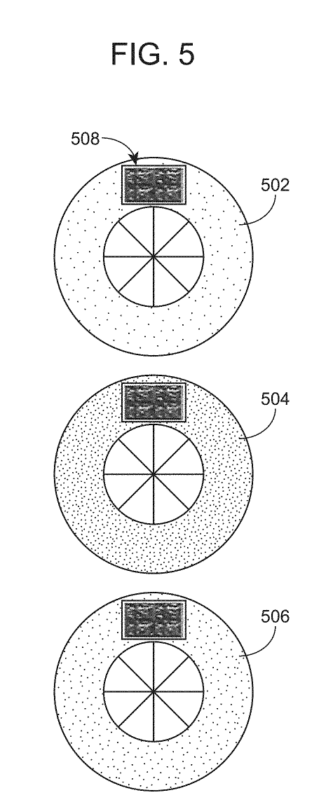

In some embodiments, the instructions cause the system to identify the type of auxiliary reagent present in the introduced auxiliary reagent container based on an image captured by the camera of an identification code present on the introduced auxiliary reagent container. One example of such an embodiment is shown in FIG. 5. Shown are auxiliary reagent container caps 502, 504 and 506 of three auxiliary reagent containers (not shown). Disposed on the cap of each auxiliary reagent container is an identification code—in this example, a two-dimensional code, e.g., QR code 508 present on auxiliary reagent container cap 502. The instructions cause the system to identify the type of auxiliary reagents introduced to the auxiliary reagent storage area based on images captured by the camera of the identification codes present on auxiliary reagent container caps 502, 504 and 506.

In some embodiments, the instructions cause the system to, using the camera, inventory consumables, reagents, or both, present at the one or more consumable or reagent storage areas. For example, the instructions may cause the camera positioning means to sequentially, periodically and/or continually position the camera in optical communication with the one or more consumable or reagent storage areas of the system, to capture images of consumables and/or reagents at the storage areas. Based on the images, the system may determine the presence, amount, and/or the like of consumables and/or reagents at the storage areas. In certain aspects, the instructions cause the system to compare inventory information obtained using the camera to inventory information stored on the system not obtained using the camera. Such a comparison may be used, e.g., for confirming whether inventory information stored on the system not obtained using the camera is correct.

Automated functions of the analysis systems may be carried out using one or more data processing units and/or computer-related elements to control electromechanical aspects of the system and/or perform various digital processing functions, such as, e.g., image processing functions. Accordingly, many of the component elements described above may be operably connected (e.g., through a wired or wireless data connection) to one or more computer controllers.

Components of the analysis systems of the present disclosure may be connected by a wired data connection. Any suitable and appropriate wired data connection may find use in connecting the components of the described systems, e.g., as described herein, including but not limited to e.g., commercially available cables such as a USB cable, a coaxial cable, a serial cable, a C2G or Cat2 cable, a Cat5/Cat5e/Cat6/Cat6a cable, a Token Ring Cable (Cat4), a VGA cable, a HDMI cable, a RCA cable, an optical fiber cable, and the like. In some instances, wireless data connections may be employed including but not limited to e.g., radio frequency connections (e.g., PAN/LAN/MAN/WAN wireless networking, UHF radio connections, etc.), an infrared data transmission connection, wireless optical data connections, and the like.

As summarized above, an analysis system of the present disclosure includes one or more non-transitory computer-readable media including instructions for causing the system to perform various functions. In certain embodiments, instructions in accordance with the systems and methods described herein can be coded onto a non-transitory computer-readable medium in the form of “programming”, where the term “computer readable medium” as used herein refers to any storage or transmission medium that participates in providing instructions and/or data to a computer for execution and/or processing. Examples of storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer.

The instructions may be in the form of programming that is written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as many others.

### Methods

As summarized above, the present disclosure provides automated methods implemented by an analysis system. In some embodiments, the methods include detecting when a consumable or reagent has been introduced to one or more consumable or reagent storage areas of an analysis system, positioning a camera in optical communication with the introduced consumable or reagent, and using the camera, identifying the introduced consumable or reagent.

As will be appreciated, the methods of the present disclosure may include any of the analysis system functions, or employ any of the analysis system components (e.g., camera, camera positioning means, one or more consumable or reagent storage areas, etc.) described above in the section describing the analysis systems of the present disclosure.

As described above, in some embodiments, the camera employed by the methods is a digital camera, e.g., a camera adapted to read (e.g., capture images of) identification codes present on the introduced consumable or reagent, such as any of the identification codes (e.g., barcodes, etc.) and consumables or reagents described elsewhere herein.

As described above, in certain aspects, positioning a camera in optical communication with the introduced consumable or reagent includes moving the camera in 2 or more dimensions. For example, positioning a camera in optical communication with the introduced consumable or reagent may include moving the camera in X, Y and Z axes. Positioning a camera in optical communication with the introduced consumable or reagent may include moving the camera with a linear actuator, a rotary actuator, or both. In some embodiments, positioning a camera in optical communication with the introduced consumable or reagent includes moving the camera with one or more motors. The one or more motors may include a drive motor. In some embodiments, the motor is coupled to a position sensor, e.g., the motor may be a servo motor.

As described above, an analysis system may include a pipettor head and pipettor head positioning means. According to such embodiments, positioning a camera in optical communication with the introduced consumable or reagent may include positioning the camera with the pipettor head positioning means. In certain aspects, the camera is mounted on the pipettor head positioning means proximate to the pipettor head, as described above. In other aspects, the camera is mounted on the pipettor head. In some embodiments, positioning a camera in optical communication with the introduced consumable or reagent includes positioning the camera using a robotic arm.

In certain aspects, the methods of the present disclosure include detecting when a consumable has been introduced to one or more consumable storage areas of the analysis system. The detecting may include detecting when a pipette tip rack has been introduced to the one or more consumable storage areas. According to such embodiments, the methods may include positioning the camera in optical communication with the introduced pipette tip rack. The methods may further include identifying the type of pipette tips present in the introduced pipette tip rack using the camera. The identifying may be based on a dimension of the pipette tips. In some embodiments, the dimension is of filters present in the pipette tips. Alternatively, or additionally, the identifying may be based on an image captured by the camera of an identification code present on the introduced pipette tip rack. In certain aspects, the methods include identifying the number of pipette tips present in the introduced pipette tip rack.

In certain aspects, the methods of the present disclosure include detecting when a reagent has been introduced to one or more reagent storage areas of the analysis system. In some embodiments, the reagent is an assay reagent, e.g., present in an assay reagent plate. The methods may include identifying the type of assay reagent based on an identification code present on the assay reagent plate. In some embodiments, the reagent is an auxiliary reagent, e.g., present in an auxiliary reagent container. The methods may include identifying the type of auxiliary reagent based on an identification code present on the auxiliary reagent container.

In some embodiments, the methods further include, using the camera, inventorying consumables, reagents, or both, present at the one or more consumable or reagent storage areas of the analysis system. Such methods may further include, e.g., comparing inventory information obtained using the camera to inventory information stored on the system not obtained using the camera.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. An analysis system, comprising:
one or more consumable or reagent storage areas;
a camera;
camera positioning means for positioning the camera in optical communication with the one or more consumable or reagent storage areas; and
one or more non-transitory computer-readable media comprising instructions that cause the system to:
detect when a consumable or reagent has been introduced to the one or more consumable or reagent storage areas;
using the camera positioning means, position the camera in optical communication with the introduced consumable or reagent; and
using the camera, identify the introduced consumable or reagent.

2. The analysis system of claim 1, wherein the camera is a digital camera.

3. The analysis system of claim 1, wherein the camera is adapted to read identification codes.

4. The analysis system of claim 3, wherein the identification codes are barcodes.

5. The analysis system of claim 1, wherein the camera positioning means comprises means for moving the camera in 2 or more dimensions.

6. The analysis system of claim 5, wherein the camera positioning means comprises means for moving the camera in X, Y and Z axes.

7. The analysis system of claim 1, wherein the camera positioning means comprises a linear actuator.

8. The analysis system of claim 1, wherein the camera positioning means comprises a rotary actuator.

9. The analysis system of claim 1, wherein the camera positioning means comprises a motor.

10. The analysis system of claim 9, wherein the camera positioning means comprises a drive motor.

11. The analysis system of claim 9, wherein the camera positioning means comprises a motor coupled to a position sensor.

12. The analysis system of claim 11, wherein the camera positioning means comprises a servo motor.

13. The analysis system of claim 1, wherein the analysis system comprises a pipettor head and pipettor head positioning means.

14. The analysis system of claim 13, wherein the pipettor head positioning means is the camera positioning means.

15. The analysis system of claim 14, wherein the camera is mounted on the pipettor head positioning means proximate to the pipettor head.

16. The analysis system of claim 14, wherein the camera is mounted on the pipettor head.

17. The analysis system of claim 1, wherein the camera positioning means comprises a robotic arm.

18. The analysis system of claim 1, wherein the one or more consumable or reagent storage areas comprises one or more consumable storage areas.

19. The analysis system of claim 18, wherein the instructions cause the system to detect when a pipette tip rack has been introduced to the one or more consumable storage areas.

20. The analysis system of claim 19, wherein the instructions cause the system to, using the camera positioning means, position the camera in optical communication with the introduced pipette tip rack.

21. The analysis system of claim 20, wherein the instructions cause the system to, using the camera, identify the type of pipette tips present in the introduced pipette tip rack.

22. The analysis system of claim 21, wherein the instructions cause the system to identify the type of pipette tips present in the introduced pipette tip rack based on a dimension of the pipette tips.

23. The analysis system of claim 22, wherein the dimension is of filters present in the pipette tips.

24. The analysis system of claim 21, wherein the instructions cause the system to identify the type of pipette tips present in the introduced pipette tip rack based on an identification code present on the introduced pipette tip rack.

25. The analysis system of claim 20, wherein the instructions cause the system to, using the camera, identify the number of pipette tips present in the introduced pipette tip rack.

26. The analysis system of claim 1, wherein the one or more consumable or reagent storage areas comprises one or more reagent storage areas.

27. The analysis system of claim 26, wherein the instructions cause the system to detect when an assay reagent plate has been introduced to the one or more reagent storage areas.

28. The analysis system of claim 27, wherein the instructions cause the system to, using the camera positioning means, position the camera in optical communication with the introduced assay reagent plate.

29. The analysis system of claim 28, wherein the instructions cause the system to, using the camera, identify the type of assay reagents present in the introduced assay reagent plate.

30. The analysis system of claim 29, wherein the instructions cause the system to identify the type of assay reagents present in the introduced assay reagent plate based on the reading of an identification code present on the introduced assay reagent plate by the camera.

31. The analysis system of claim 27, wherein the assay reagent plate is present in an assay reagent plate carrier comprising two or more assay reagent plates.

32. The analysis system of claim 31, wherein the instructions cause the system to identify the type of assay reagents present in each of the two or more assay reagent plates based on the reading of an identification code present on each of the two or more assay reagent plates by the camera.

33. The analysis system of claim 26, wherein the instructions cause the system to detect when an auxiliary reagent container has been introduced to the one or more reagent storage areas.

34. The analysis system of claim 33, wherein the instructions cause the system to, using the camera positioning means, position the camera in optical communication with the introduced auxiliary reagent container.

35. The analysis system of claim 34, wherein the instructions cause the system to, using the camera, identify the type of auxiliary reagent present in the introduced auxiliary reagent container.

36. The analysis system of claim 35, wherein the instructions cause the system to identify the type of auxiliary reagent present in the introduced auxiliary reagent container based on the reading of an identification code present on the introduced auxiliary reagent container by the camera.

37. The analysis system of claim 1, wherein the instructions cause the system to, using the camera, inventory consumables, reagents, or both, present at the one or more consumable or reagent storage areas.

38. The analysis system of claim 37, wherein the instructions cause the system to compare inventory information obtained using the camera to inventory information stored on the system.

39. The analysis system of claim 1, wherein the analysis system is an automated quantitative polymerase chain reaction (qPCR) analysis system.

40. The analysis system of claim 1, wherein the analysis system is a hematology analysis system.

41-73. (canceled)
